(19) United States
(12) Patent Application Publication
(10) Pub. No.: US 2026/0035537 A1
(43) Pub. Date: Feb. 5, 2026

(54) RECYCLED SILICA PARTICLES

(71) Applicant: SAINT-GOBAIN PERFORMANCE PLASTICS CORPORATION, Malvern, PA (US)

(72) Inventors: Shuai LIANG, Southborough, MA (US); Zichao Wei, Brighton, MA (US); Robert Barrentine, Seattle, WA (US); Hua Wang, Northbridge, MA (US); Nicolas Drolet, Chelmsford, MA (US)

(21) Appl. No.: 19/287,491

(22) Filed: Jul. 31, 2025

Related U.S. Application Data
(60) Provisional application No. 63/677,499, filed on Jul. 31, 2024.

(51) Int. Cl. C08J 11/28; C01B 33/18

(52) U.S. Cl. CPC C08J 11/28; C01B 33/18; C01P 2002/82; C01P 2004/03

(57) ABSTRACT

A population of recycled silica particles includes: a plurality of individual silica particles, wherein the silica particles are hydrophobic. Further disclosed is a method of recycling a commercially available polymer article including: a) providing the commercially available polymer article; b) mechanically breaking the article into multiple polymer pieces, wherein the polymer includes at least one silicon-oxygen bond and a reinforcing silica filler; c) mixing a mixture including the polymer pieces, a solvent, and a catalyst, wherein the mixture provides a polymer oil and a population of recycled silica particles; and d) separating the polymer oil and the population of recycled silica particles from the mixture, wherein the population of recycled silica particles provides a plurality of individual silica particles.

### CROSS-REFERENCE TO RELATED APPLICATION(S)

This application claims priority under 35 U.S.C. § 119 (e) to U.S. Provisional Patent Application No. 63/677,499 entitled “RECYCLED SILICA PARTICLES,” filed Jul. 31, 2024, by Shuai LIANG et al., which is assigned to the current assignee hereof and is incorporated herein by reference in its entirety.

### FIELD OF THE DISCLOSURE

This application in general relates to a recycled silica particle and a method for recycling a polymeric article.

### BACKGROUND

Silicone-containing polymeric materials are widely used for their properties desired in the medical, pharmaceutical, food, and biological industries. For instance, silicone-containing polymeric materials typically are non-toxic, flexible, thermally stable, have low chemical reactivity, and can be produced in a variety of sizes. With silicone-containing polymeric materials, the widespread use creates issues with consumption, waste, and environmental considerations. Accordingly, it would be advantageous to recycle silicone-containing polymeric materials for sustainability.

Previous methods to depolymerize silicone-containing polymeric materials can be problematic. For instance, typical methods require high temperatures and high pressure, conditions which are both environmentally and financially less desirable. As such, an improved method of recycling silicone-containing polymeric materials is desired.

### SUMMARY

In an embodiment, a population of recycled silica particles includes: a plurality of individual silica particles, wherein the silica particles are hydrophobic.

In another embodiment, a method of recovering a population of recycled silica particles is provided. The method includes: a) providing a commercially available silicone article; b) mechanically breaking the silicone article into multiple silicone pieces; c) mixing a mixture comprising the silicone pieces, a solvent, and a catalyst, wherein the mixture provides a silicone oil and the population of recycled silica particles; and d) separating the population of recycled silica particles from the solvent to provide a plurality of individual silica particles.

In yet another embodiment, a method of recycling a commercially available polymer article is provided. The method includes: a) providing the commercially available polymer article; b) mechanically breaking the article into multiple polymer pieces, wherein the polymer includes at least one silicon-oxygen bond and a reinforcing silica filler; c) mixing a mixture including the polymer pieces, a solvent, and a catalyst, wherein the mixture provides a polymer oil and a population of recycled silica particles; and d) separating the polymer oil and the population of recycled silica particles from the mixture, wherein the population of recycled silica particles provides a plurality of individual silica particles.

In an embodiment, a polymer oil recovered from a process of recycling a commercially available polymer article is provided. The process includes: a) providing the commercially available polymer article; b) mechanically breaking the article into multiple polymer pieces, wherein the polymer includes at least one silicon-oxygen bond and a reinforcing silica filler; c) mixing a mixture including the polymer pieces, a solvent, and a catalyst, wherein the mixture provides a polymer oil and a population of recycled silica particles; and d) separating the polymer oil from the mixture.

In yet another embodiment, a method of recovering a polymer oil is provided. The method includes: a) providing a commercially available polymer article; b) mechanically breaking the article into multiple polymer pieces, wherein the polymer includes at least one silicon-oxygen bond and a reinforcing silica filler; c) mixing a mixture including the polymer pieces, a solvent, and a catalyst, wherein the mixture provides a polymer oil and a population of recycled silica particles; d) distilling the polymer oil from the mixture; and e) recovering the polymer oil.

### BRIEF DESCRIPTION OF THE DRAWINGS

The present disclosure may be better understood, and its numerous features and advantages made apparent to those skilled in the art by referencing the accompanying drawings.

FIG. 1 includes an illustration of an exemplary method according to an embodiment.

FIG. 2 includes comparative scanning electron microscopy (SEM) images of recycled silica particles versus non-recycled commercially available silica particles.

FIG. 3 includes an ATR-FTIR spectra of recycled, vinyl-functionalized polymer oil and a commercially available vinyl-functionalized polymer oil.

The use of the same reference symbols in different drawings indicates similar or identical items.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having” or any other variation thereof, are open-ended terms and should be interpreted to mean “including, but not limited to . . . ” These terms encompass the more restrictive terms “consisting essentially of” and “consisting of.” In an embodiment, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in reference books and other sources within the structural arts and corresponding manufacturing arts. Unless indicated otherwise, all measurements are at about 23° C.+/−5° C. per ASTM.

In an embodiment, a population of recycled silica particles includes a plurality of individual silica particles. The plurality of individual silica particles has advantageous and unexpected properties, such as hydrophobicity and catalytic reactivity. The population of recycled silica particles is recovered from recycling a commercially available silicon-oxygen (Si—O) containing polymeric article.

In an embodiment, the commercially available polymeric article is formed from at least a polymer having at least one silicon-oxygen bond and a reinforcing silica filler. The reinforcing silica filler is typically used in commercially available polymeric articles to provide desirable mechanical and rheological properties. Reinforcing silica filler is typically used to modify properties such as modulus, tensile strength, tear strength, hydrophobicity, rheological properties, and the like. In an embodiment, the reinforcing silica filler may make up at least 5 weight % to 40 weight % of the commercially available polymeric article. Reinforcing silica filler may also be described as fumed silica particles, colloidal silica, precipitated silica particles, and the like.

Any polymer having at least one silicon-oxygen bond for the commercially available polymeric article is envisioned. In an embodiment, the polymer having at least one silicon-oxygen bond includes a silicone rubber. The silicone rubber contains silicon-oxygen bonds at least along a backbone of the polymer. Any silicone rubber is envisioned and includes, for example, a liquid silicone rubber, a high consistency rubber, a room temperature vulcanized rubber, a hyperbranched silicone resin, a polyhedral oligomeric silsesquioxane, or combination thereof. In a more particular embodiment, the silicone rubber is platinum-cured.

In another embodiment, the polymer has a carbon-based backbone with at least one organofunctional group having a silicon-oxygen end group, i.e., a silane-termination. In an embodiment, the polymer having the carbon-based backbone polymer with the silane-termination may include a silane-terminated polyacrylate, a silane-terminated butyl rubber, a silane-terminated neoprene, a silane-terminated phenolic resin, a silane-terminated polyamide, a silane-terminated polyether, a silane-terminated epoxy resin, a silane-terminated melamine, a silane-terminated polyester, a silane-terminated polyolefin, a silane-terminated polysulfide, a silane-terminated polyurethane, a silane-terminated ethylene propylene rubber (EPR), a silane-terminated ethylene propylene diene monomer (EPDM), a silane-terminated styrene-butadiene rubber (SBR), or combination thereof. The organofunctional group with the silane-termination may include any reasonable organofunctional group compatible with the polymer and includes, but is not limited to, an amino group, an epoxy group, a methacrylic group, a vinyl group, an isocyanate group, a mercapto group, or combination thereof. Any reasonable combination of organofunctional group and polymer is envisioned and is dependent on the properties desired for the commercially available polymeric article. In an embodiment, the polymer is a silane-terminated polyester, a silane-terminated polyether, a silane-terminated polyurethane, or combination thereof.

The commercially available polymeric article for recycling can include post-industrial polymeric articles, pre-consumer polymeric articles, post-consumer polymeric articles, scrap polymeric articles, or any combination thereof. Post-industrial polymeric articles can include partially or completely manufactured polymeric articles that remain within the possession of the manufacturer. Post-consumer polymeric articles can include polymeric articles that have been used and/or controlled by a consumer, such as a medical, pharmaceutical, or industrial business. Pre-consumer polymeric articles are completely manufactured polymeric articles outside the possession of the manufacturer and before the polymeric articles are used. An example of pre-consumer polymeric articles can include an article that is damaged by a shipping company during shipping or handling, or obsolete products, or expired products (e.g., a product that should not be used due to age of the product). Any polymeric article is envisioned and includes, for example, a tubing, a bag, a connector, a septum, a nozzle, a closure, a valve, a sealant, an adhesive, a tape, a foam, a pad, a prosthesis, and the like.

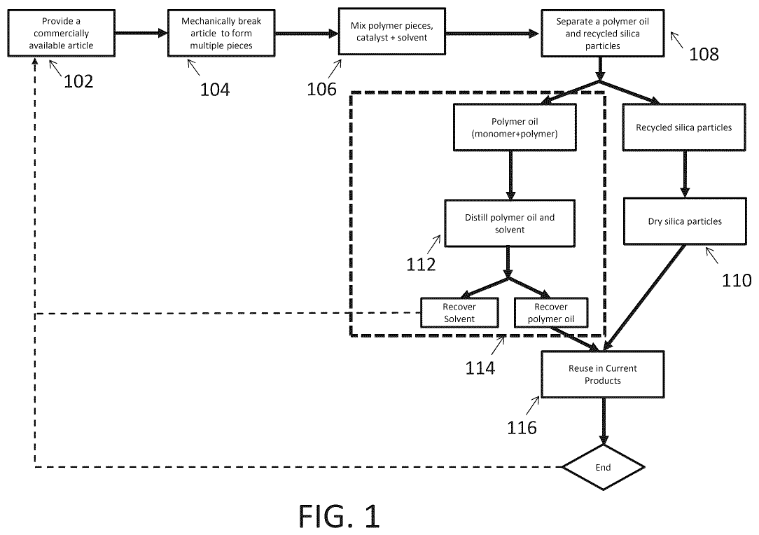

In an embodiment, the commercially available polymeric article is processed to recover at least a population of recycled silica particles, a polymer oil, or combination thereof. The process of recovering recycled silica particles can be seen in FIG. 1. The process includes recycling a commercially available polymeric article. Step 102 includes providing the commercially available polymeric article. Any polymeric article is envisioned and is discussed above. As seen in Step 104, the commercially available polymeric article is mechanically broken into smaller pieces. For instance, the polymeric article is processed and mechanically ground or shredded to provide for a desirable particle size prior to chemical depolymerization. Any method of mechanically grinding the polymeric article is envisioned and includes, for example, cryogenic grinding, ball milling, blade cutting, and the like. In an embodiment, the desirable particle size prior to chemical depolymerization is 1 μm to 1000 μm. Once the desirable size is achieved, the polymeric pieces are placed in a mixture including a solvent and a catalyst, as seen in Step 106. The mixture may be maintained at room temperature for any reasonable period of time to obtain the polymer oil and recycled silica particles. In an embodiment, the time is at least 10 minutes, such as 10 minutes to 24 hours.

Any reasonable solvent is envisioned that assists in the depolymerization of the polymeric article. In an embodiment, the solvent has high to medium polarity. In an embodiment, the solvent is an ether, a heterocyclic monomer, N-methyl-2-pyrrolidone, dimethylformamide, cyrene, γ-valerolactone, dimethyl isosorbide, tetrahydrofuran, 2-methyl tetrahydrofuran, cyclopentyl methyl ether, acetone, dimethyl sulfoxide, ethyl acetate, or combination thereof. In a particular embodiment, the solvent is an ether such as a cyclopentyl methyl ether, tetrahydrofuran, 2-methyl tetrahydrofuran, or combination thereof. In an embodiment, the solvent may be derived from a bioresource.

In an embodiment, any catalyst is envisioned that breaks the silicon-oxygen bond. In an embodiment, the catalyst provides a source of fluoride and includes, for example, tetra-n-butylammonium fluoride, tetra-n-methylammonium fluoride, tetra-n-ethylammonium fluoride, a fluoride-containing ionic liquid with pyridine, a fluoride-containing ionic liquid with imidazole, hydrogen fluoride, sulfur hexafluoride, a silicofluoride, an alkali metal fluoride, or combination thereof. Any amount of catalyst is envisioned to depolymerize the polymeric article into a polymer oil and a population of recycled silica particles. In an embodiment, the catalyst is present at an amount of 10 ppm to 1000 μm, based on the total weight of the mixture.

In Step 108, the polymer oil and recycled silica particles are separated from the mixture. Separation of the polymer oil and the recycled silica particles may be achieved by any reasonable method and includes, for instance, centrifugation, filtration, or combination thereof. The polymer oil and/or the population of recycled silica particles may be recovered with any further processing methods envisioned. For instance, the population of recycled silica particles may be dried under any reasonable conditions, as seen in Step 110. In an embodiment, conditions include drying at a temperature of 70° C. to 100° C. for at least 18 hours. Further, the polymer oil and solvent may be distilled at Step 112. The resulting solvent and polymer oil may be recovered at Step 114. Further, the recycled silica particles, recovered polymer oil, or combination thereof may be reused in Step 116. In an embodiment, the solvent may also be reused.

The population of recycled silica particles have unexpected and advantageous properties. In particular, the recycled silica particles result in a plurality of individual silica particles that are hydrophobic. For instance, the hydrophobic plurality of silica particles have a surface having a water contact angle of greater than 50°, such as greater than 75°, such as greater than 90°, such as greater than 100°, such as greater than 110°, such as greater than 120°, such as greater than 125°, or even greater than 150°. In contrast, typical commercially available silica particles that are not recycled have a water contact angle of less than 50°. In an embodiment, hydrophobic particles typically have a water contact angle of greater than 90°.

Any particle size of the plurality of individual silica particles is envisioned that provides a stable, workable formulation with or without dispersion additives. In an embodiment, the recycled silica particles have a D50 particle size of greater than 15 μm, such as greater than 20 μm when dispersed in a solvent, as measured by Dynamic Light Scattering. In an embodiment, the recycled silica particles have a surface area of 120 m²/g to 400 m²/g, such as 120 m²/g to 300 m²/g, such as 120 m²/g to 200 m²/g, such as 120 m²/g to 170 m²/g, such as 130 m²/g to 160 m²/g, such as 140 m²/g to 150 m²/g. In an embodiment, the recycled silica particles have a degradation temperature of greater than 300° C., such as greater than 350° C., such as greater than 400° C., such as greater than 450° C., or even greater than 500° C. with a degradation percentage of 5% to 15%. In contrast, typical commercially available silica particles that are not recycled have a degradation temperature of less than 250° C. with a degradation percentage of less than 5%.

In an embodiment, the recycled silica particles can be re-used in a siloxane-containing polymer article formulation to produce a new silicone article. In an exemplary embodiment, the recycled silica particles are catalytically reactive. In a particular embodiment, the re-used, recycled silica particles can be used as both a filler and a catalytic reactant. For instance, the recycled silica particles may be a source of a hydrosilylation catalyst when used in a subsequent siloxane-containing polymer article formulation including reactive groups to form a polyorganosiloxane polymer. For instance, the recycled silica particles include a platinum content in the form of platinum ions, platinum nanoparticles, platinum organic complexes, or combination thereof. The platinum content is at a level to provide a catalytic reaction and is at least 1.0 ppm, such as at least 3.0 ppm, such as at least 5.0 ppm, or even at least 8.0 ppm. In a particular embodiment, the platinum content is embedded within the silica particles. In contrast, typical commercially available silica particles that are not recycled do not have catalytic reactivity.

Due to the catalytic reactivity of the recycled silica particles, the siloxane-containing polymer article formulation may be substantially free of a separate catalyst, such as, a separate, additional hydrosilylation reaction catalyst. For instance, an exemplary separate, additional hydrosilylation catalyst is an organometallic complex compound of a transition metal. In an embodiment, the separate, additional hydrosilylation reaction catalyst includes platinum, rhodium, ruthenium, the like, or combinations thereof. Further, the siloxane-containing polymer article formulation may be substantially free of optional separate catalysts that are typically used with silicone elastomer formulations. Exemplary optional separate, additional catalysts may include peroxide, tin, or combinations thereof. “Substantially free” as used herein refers to less than 5 wt % of the total weight of the siloxane-containing polymer article formulation.

The siloxane-containing polymer article formulation may, for example, include polyalkylsiloxanes, such as silicone polymers formed of a precursor, such as dimethylsiloxane, diethylsiloxane, dipropylsiloxane, methylethylsiloxane, methylpropylsiloxane, or combinations thereof. In a particular embodiment, the polyalkylsiloxane includes a polydialkylsiloxane, such as polydimethylsiloxane (PDMS). In a particular embodiment, the polyalkylsiloxane is a silicone hydride-containing polyalkylsiloxane, such as a silicone hydride-containing polydimethylsiloxane. In a further embodiment, the polyalkylsiloxane is a vinyl-containing polyalkylsiloxane, such as a vinyl-containing polydimethylsiloxane. In yet another embodiment, the silicone polymer is a combination of a hydride-containing polyalkylsiloxane and a vinyl-containing polyalkylsiloxane, such as a combination of hydride-containing polydimethylsiloxane and a vinyl-containing polydimethylsiloxane.

As discussed, due to the catalytic reactivity of the recycled silica particles, the recycled silica particles may be used for a dual purpose of both a filler and a hydrosilylation catalyst. The recycled silica particles may cause a reaction, for instance, between the hydride-containing polyalkylsiloxane and the vinyl-containing polyalkylsiloxane to form a silicone elastomer resin without the need for any separate, additional hydrosilylation reaction catalyst.

In addition to the recycled silica particles, the polymer oil may be recovered from the recycling of the commercially available polymeric article. The polymer oil obtained is dependent on the composition of the starting polymeric article. For instance, when the polymeric article is a silicone article, the recovered polymer oil is a polydimethylsiloxane. In an embodiment and when the polymer is the carbon-based backbone with an organofunctional group having a silicon-oxygen end group, the polymer oil obtained is the carbon-based backbone polymer, wherein the silicon-oxygen end group is cleaved from the carbon-based backbone. In an example, the polymer includes a silane-terminated polyether, a silane-terminated polyester, or a silane-terminated polyurethane and once recycled, the resulting polymer oil is a polyether, a polyester, or a polyurethane, respectively. The polymer oil may be re-used in any product where the polymer oil would be useful. In an embodiment, the polymer oil can be reused as a polymer matrix for products such as, for example, an adhesive, a sealant, a foam, a tape, a wetting agent, a medical device, a pad, and the like. In an embodiment, the polymer oil has an average weight molecule weight range of 500 g/mol to 500,000 g/mol.

In an embodiment, the polymer oil may be functionalized with any reasonable functional group envisioned. Any method of functionalization is envisioned. In a particular embodiment, the polymer oil includes a vinyl, a hydride, an amino, an epoxy, a methacrylate, a phenyl, a hydroxyl, an alkoxy, an isocyanate, a carboxylic acid, a thiol, a polyether, a fluoroalkyl, or a combination thereof. In a more particular embodiment, the recovered polymer oil includes a vinyl-functionalized polydimethylsiloxane. In an example, the polymer oil may be functionalized for a structure being a telechelic polymer, a hyperbranched polymer, a random copolymer, a block copolymer, or any combination thereof.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the items as listed below.

Embodiment 1. A population of recycled silica particles, including: a plurality of individual silica particles, wherein the silica particles are hydrophobic.

Embodiment 2. The population of embodiment 1, wherein the hydrophobic silica particles have a surface having a water contact angle of greater than 50°, such as greater than 75°, such as greater than 100°, such as greater than 125°, or even greater than 150°.

Embodiment 3. The population of any one of the preceding embodiments, wherein the silica particles are catalytically reactive.

Embodiment 4. The population of any one of the preceding embodiments, wherein the silica particles include a platinum content in the form of platinum ions, platinum nanoparticles, platinum organic complexes, or combination thereof.

Embodiment 5. The population of embodiment 3, wherein the platinum content is at least 1.0 ppm weight.

Embodiment 6. The population of any one of embodiments 3 to 5, wherein the platinum content is embedded within the silica particles.

Embodiment 7. The population of any one of the preceding embodiments, wherein the silica particles have a degradation temperature of greater than 300° C., such as greater than 350° C., such as greater than 400° C., such as greater than 450° C., or even greater than 500° C. with a degradation percentage of 5% to 15%.

Embodiment 8. The population of any one of the preceding embodiments, wherein the silica particles have a surface area of 120 m²/g to 400 m²/g, such as 120 m²/g to 170 m²/g, such as 130 m²/g to 160 m²/g, such as 140 m²/g to 150 m²/g.

Embodiment 9. The population of any of the preceding embodiments, wherein the silica particles have a D50 particle size of greater than 15 μm, such as greater than 20 μm when dispersed in a solvent.

Embodiment 10. The population of any one of the preceding embodiments, wherein the silica particles are recycled from a commercially available article including a polymer with at least one silicon-oxygen bond and a reinforcing silica filler.

Embodiment 11. The population of embodiment 10, wherein the polymer includes a silicone rubber, a silane-terminated polyether, a silane-terminated polyester, a silane-terminated polyurethane, or combination thereof.

Embodiment 12. The population of any one of embodiments 10 to 11, wherein the silicone rubber includes a liquid silicone rubber, a high consistency rubber, a room temperature vulcanized rubber, a hyperbranched silicone resin, a polyhedral oligomeric silsesquioxane, or combination thereof.

Embodiment 13. A method of recovering a population of recycled silica particles including: a) providing a commercially available silicone article; b) mechanically breaking the silicone article into multiple silicone pieces; c) mixing a mixture comprising the silicone pieces, a solvent, and a catalyst, wherein the mixture provides a silicone oil and the population of recycled silica particles; and d) separating the population of recycled silica particles from the solvent to provide a plurality of individual silica particles.

Embodiment 14. The method of embodiment 13, wherein the silicone article includes a liquid silicone rubber, a high consistency rubber, a room temperature vulcanized rubber, a hyperbranched silicon resin, a polyhedral oligomeric silsesquioxane, or combination thereof.

Embodiment 15. The method of any one of embodiments 13 or 14, wherein the catalyst includes a source of fluoride.

Embodiment 16. The method of any one of embodiments 13 to 15, wherein the catalyst includes tetra-n-butylammonium fluoride, tetra-n-methylammonium fluoride, tetra-n-ethylammonium fluoride, a fluoride-containing ionic liquid with pyridine, a fluoride-containing ionic liquid with imidazole, hydrogen fluoride, sulfur hexafluoride, a silicofluoride, an alkali metal fluoride, or combination thereof.

Embodiment 17. The method of any one of embodiments 13 to 16, wherein the solvent includes an ether, a heterocyclic monomer, N-methyl-2-pyrrolidone, dimethylformamide, cyrene, γ-valerolactone, dimethyl isosorbide, tetrahydrofuran, 2-methyl tetrahydrofuran, cyclopentyl methyl ether, acetone, dimethyl sulfoxide, ethyl acetate, or combination thereof.

Embodiment 18. The method of any one of embodiments 13 to 17, further including drying the plurality of silica particles.

Embodiment 19. The method of embodiment 18, wherein drying is at a temperature of 70° C. to 100° C. for at least 18 hours.

Embodiment 20. The method of any one of embodiments 13 to 19, wherein the silica particles are hydrophobic.

Embodiment 21. The method of embodiment 20, wherein the hydrophobic silica particles have a surface having a water contact angle of greater than 50°, such as greater than 75°, such as greater than 100°, such as greater than 125°, or even greater than 150°.

Embodiment 22. The method of any one of embodiments 13 to 21, wherein the silica particles are catalytically reactive.

Embodiment 23. The method of any one of embodiments 13 to 22, wherein the silica particles include a platinum content in the form of platinum ions, platinum nanoparticles, platinum organic complexes, or combination thereof.

Embodiment 24. The method of embodiment 23, wherein the platinum content is at least 1.0 ppm weight.

Embodiment 25. The method of any one of embodiments 23 to 24, wherein the platinum content is embedded within the silica particles.

Embodiment 26. The method of any one of embodiments 13 to 25, wherein the silica particles have a degradation temperature of greater than 300° C., such as greater than 350° C., such as greater than 400° C., such as greater than 450° C., or even greater than 500° C. with a degradation percentage of 5% to 15%.

Embodiment 27. The method of any one of embodiments 13 to 26, wherein the silica particles have a surface area of 120 m²/g to 400 m²/g, such as 120 m²/g to 170 m²/g, such as 130 m²/g to 160 m²/g, such as 140 m²/g to 150 m²/g.

Embodiment 28. The method of any one of the embodiments 13 to 27, wherein the silica particles have a D50 particle size of greater than 15 μm, such as greater than 20 μm when dispersed in a solvent.

Embodiment 29. The method of any one of embodiments 13 to 28, wherein the silicone oil includes a polydimethylsiloxane.

Embodiment 30. A method of recycling a commercially available polymeric article including: a) providing the commercially available polymer article; b) mechanically breaking the article into multiple polymer pieces, wherein the polymer includes at least one silicon-oxygen bond and a reinforcing silica filler; c) mixing a mixture including the polymer pieces, a solvent, and a catalyst, wherein the mixture provides a polymer oil and a population of recycled silica particles; and d) separating the polymer oil and the population of recycled silica particles from the mixture, wherein the population of recycled silica particles provides a plurality of individual silica particles.

Embodiment 31. The method of embodiment 30, wherein the polymer includes a silane-terminated polyether, a silane-terminated polyester, a silane-terminated polyurethane, a silicone rubber, or combination thereof.

Embodiment 32. The method of embodiment 31, wherein the silicone rubber includes a liquid silicone rubber, a high consistency rubber, a room temperature vulcanized rubber, a hyperbranched silicone resin, a polyhedral oligomeric silsesquioxane, or combination thereof.

Embodiment 33. The method of embodiment 31, wherein the polymer oil includes polydimethylsiloxane.

Embodiment 34. The method of embodiment 32, wherein the polymer oil includes polyether, a polyester, a polyurethane, or combination thereof.

Embodiment 35. The method of any one of embodiments 30 to 34, wherein the catalyst includes a source of fluoride.

Embodiment 36. The method of any one of embodiments 30 to 35, wherein the catalyst includes tetra-n-butylammonium fluoride, tetra-n-methylammonium fluoride, tetra-n-ethylammonium fluoride, a fluoride-containing ionic liquid with pyridine, a fluoride-containing ionic liquid with imidazole, hydrogen fluoride, sulfur hexafluoride, a silicofluoride, an alkali metal fluoride, or combination thereof.

Embodiment 37. The method of any one of embodiments 30 to 36, wherein the solvent includes an ether, a heterocyclic monomer, N-methyl-2-pyrrolidone, dimethylformamide, cyrene, γ-valerolactone, dimethyl isosorbide, tetrahydrofuran, 2-methyl tetrahydrofuran, cyclopentyl methyl ether, acetone, dimethyl sulfoxide, ethyl acetate, or combination thereof.

Embodiment 38. The method of any one of embodiments 30 to 37, further including drying the plurality of silica particles.

Embodiment 39. The method of embodiment 38, wherein drying is at a temperature of 70° C. to 100° C. for at least 18 hours.

Embodiment 40. The method of any one of embodiments 30 to 39, wherein the silica particles are hydrophobic.

Embodiment 41. The method of embodiment 40, wherein the hydrophobic silica particles have a surface having a water contact angle of greater than 50°, such as greater than 75°, such as greater than 100°, such as greater than 125°, or even greater than 150°.

Embodiment 42. The method of any one of embodiments 30 to 41, wherein the silica particles are catalytically reactive.

Embodiment 43. The method of any one of embodiments 30 to 42, wherein the silica particles include a platinum content in the form of platinum ions, platinum nanoparticles, platinum organic complexes, or combination thereof.

Embodiment 44. The method of embodiment 43, wherein the platinum ion content is at least 1.0 ppm weight.

Embodiment 45. The method of any one of embodiments 42 to 44, wherein the platinum ions are present at least 3 ppm from a surface of the silica particles.

Embodiment 46. The method of any one of embodiments 30 to 45, wherein the silica particles have a degradation temperature of greater than 300° C., such as greater than 350° C., such as greater than 400° C., such as greater than 450° C., or even greater than 500° C. with a degradation percentage of 5% to 15%.

Embodiment 47. The method of embodiment 46, wherein the silica particles have a surface area of 1120 m²/g to 400 m²/g, such as 20 m²/g to 170 m²/g, such as 130 m²/g to 160 m²/g, such as 140 m²/g to 150 m²/g.

Embodiment 48. The method of any one of the embodiments 30 to 47, wherein the silica particles have a D50 particle size of greater than 15 μm, such as greater than 20 μm when dispersed in a solvent.

Embodiment 49. A polymer oil recovered from a process of recycling a commercially available polymer article, the process including: a) providing the commercially available polymer article; b) mechanically breaking the article into multiple polymer pieces, wherein the polymer includes at least one silicon-oxygen bond and a reinforcing silica filler; c) mixing a mixture including the polymer pieces, a solvent, and a catalyst, wherein the mixture provides a polymer oil and a population of recycled silica particles; and d) separating the polymer oil from the mixture.

Embodiment 50. The polymer oil of embodiment 49, wherein the polymer includes a silane-terminated polyether, a silane-terminated polyester, a silane-terminated polyurethane, a silicone rubber, or combination thereof.

Embodiment 51. The polymer oil of embodiment 50, wherein the silicone rubber includes a liquid silicone rubber, a high consistency rubber, a room temperature vulcanized rubber, a hyperbranched silicone resin, a polyhedral oligomeric silsesquioxane, or combination thereof.

Embodiment 52. The polymer oil of any one of embodiments 49-51, wherein the recovered polymer oil includes polydimethylsiloxane.

Embodiment 53. The polymer oil of any one of embodiments 49-51, wherein the polymer oil includes polyether, a polyester, a polyurethane, or combination thereof.

Embodiment 54. The polymer oil of any one of embodiments 49-52, wherein the catalyst includes a source of fluoride.

Embodiment 55. The polymer oil of embodiment 54, wherein the catalyst includes tetra-n-butylammonium fluoride, tetra-n-methylammonium fluoride, tetra-n-ethylammonium fluoride, a fluoride-containing ionic liquid with pyridine, a fluoride-containing ionic liquid with imidazole, hydrogen fluoride, sulfur hexafluoride, a silicofluoride, an alkali metal fluoride, or combination thereof.

Embodiment 56. The polymer oil of any one of embodiments 49-55, wherein the solvent includes an ether, a heterocyclic monomer, N-methyl-2-pyrrolidone, dimethylformamide, cyrene, γ-valerolactone, dimethyl isosorbide, tetrahydrofuran, 2-methyl tetrahydrofuran, cyclopentyl methyl ether, acetone, dimethyl sulfoxide, ethyl acetate, or combination thereof.

Embodiment 57. The polymer oil of any one of embodiments 49-56, further including distilling the polymer oil.

Embodiment 58. The polymer oil of any one of embodiments 49-57, further including separating the plurality of silica particles.

Embodiment 59. The polymer oil of any one of embodiments 49-58, wherein the silica particles are catalytically reactive.

Embodiment 60. The polymer oil of any one of embodiments 49-59, wherein the silica particles include a platinum content in the form of platinum ions, platinum nanoparticles, platinum organic complexes, or combination thereof.

Embodiment 61. The polymer oil of embodiment 60, wherein the platinum ion content is at least 1.0 ppm weight.

Embodiment 62. The polymer oil of embodiment 60, wherein the platinum content is embedded within the silica particles.

Embodiment 63. The polymer oil of any one of embodiments 49-62, wherein the polymer oil includes a functional group.

Embodiment 64. The polymer oil of embodiment 63, wherein the functional group includes a vinyl, a hydride, an amino, an epoxy, a methacrylate, a phenyl, a hydroxyl, an alkoxy, an isocyanate, a carboxylic acid, a thiol, a polyether, a fluoroalkyl, or combination thereof.

Embodiment 65. The polymer oil of embodiment 64, wherein the polymer oil includes a vinyl-containing polydimethylsiloxane.

Embodiment 66. A method of recovering a polymer oil including: a) providing a commercially available polymer article; b) mechanically breaking the article into multiple polymer pieces, wherein the polymer includes at least one silicon-oxygen bond and a reinforcing silica filler; c) mixing a mixture comprising the polymer pieces, a solvent, and a catalyst, wherein the mixture provides a polymer oil and a population of recycled silica particles; d) distilling the polymer oil from the mixture; and e) recovering the polymer oil.

Embodiment 67. The method of embodiment 66, further including functionalizing the polymer oil.

Embodiment 68. The method of any one of embodiments 66-67, wherein the polymer oil includes a vinyl-containing polydimethylsiloxane.

The following examples are provided to better disclose and teach processes and compositions of the present invention. They are for illustrative purposes only, and it must be acknowledged that minor variations and changes can be made without materially affecting the spirit and scope of the invention as recited in the claims that follow.

### EXAMPLES

### Example 1

The depolymerization of silicone tubing was performed by the wet chemistry. For example, 50 g of platinum-cured liquid silicone rubber tubing (Tubing-A) crumbs were placed into a 1 L round flask. 500 mL tetrahydrofuran was filled in a same flask. Consequently, 5 mL 1M (tributyl ammonium fluoride) TBAF solution was added to the same flask then stirred at least 8 h until all the tubing crumbs were depolymerized. The resulting solution was filtered by centrifuge under 9500 rpm for 30 minutes. The separated silica was dried for 18 hours under 80° C. The supernatant was transferred back to the original flask and 0.1 M hexamethyldisiloxane was added to the solution for another 24 h. Then the recycled silicone oil was obtained after the distillation under vacuum at 40° C. The molecular weight was characterized by gel permission chromatography (GPC) and the average molecular weight was 2800 g/mol. The Pt composition in dried silica was analyzed by Inductively Coupled Plasma Mass spectrometry (ICP-MS). It indicated the Pt amount was 8.3 ppm. The similar method was applied on platinum-cured liquid silicone rubber tubing (Tubing-B) and the molecular weight of the silicone oil was 2600 g/mol and the Pt amount on the recycled silica particles was 8.3 ppm. The contact angle was measured via an optical tensiometer from Biolin Scientific. To measure the contact angle, silica powder was mounted on a planar surface. Silica powder was carefully sprinkled and spread onto SEM conductive tape until it uniformly covered the surface. The preparation ensured an even distribution of silica powder. Contact angle measurement was subsequently performed on the prepared sample. The summarized results are shown in the Table 1.

TABLE 1

| | | | | Recycled | | |
|---|---|---|---|---|---|---|
| | | | | Silicone | Recycled | Pt amount |
| | | | | Oil | Silica | in recycled |
| | | | | Molecular | Particles | Silica |
| | | | Reaction | weight | (contact | Particles |
| Silicone | Hardness | Catalyst | temperature | (g/mol) | angle) | (ppm) |
| Tubing A | 50 | 0.1M | Room temp | 2800 | 162° | 8.3 |
| Tubing B | 65 | 0.1M | Room temp | 2600 | 160° | 8.3 |

Clearly, the silica particles obtained from recycling platinum-cured silicone tubing, A and B, were both hydrophobic (with a contact angle of 160° and) 162° and catalytically active (Pt amount).

### Example 2. STP Polymer Recycling and Collection of Silica

The depolymerization of the silane terminated polyether (STP) sealant was performed by the similar depolymerization method of Example 1. For example, 60 g of the STP sealant crumbs were placed into a 1 L round flask. 500 mL tetrahydrofuran was filled in the same flask. Consequently, 5 mL 1M TBAF solution was added to the same flask then stirred at least 8 h until all the tubing crumbs were depolymerized. The resulting solution was filtered by centrifuge under 9500 rpm for 30 minutes. The separated silica was dried for 18 h under 80° C. Then the recycled polymer oil was obtained after the distillation under vacuum at 40° C. Table 2 shows the molecular weights of the STP sealant after depolymerization compared to an uncured, commercially available STP sealant (i.e. uncured STP). The molecular weight was characterized by gel permission chromatography (GPC) and the average molecular weight was 104100 g/mol for the STP sealant after depolymerization.

TABLE 2

| | Peak | Mw (Da) | Mn (Da) | PDI |
|---|---|---|---|---|
| STP-After | 1 | 104,100 | 82,400 | 1.3 |
| Depolymerization | 2 | 24,400 | 17,700 | 1.4 |
| | Total | 67,400 | 30,600 | 2.2 |
| Uncured STP | 1 | 395,000 | 140,000 | 2.8 |
| | 2 | 27,300 | 24,800 | 1.1 |
| | Total | 279,400 | 56,900 | 4.5 |

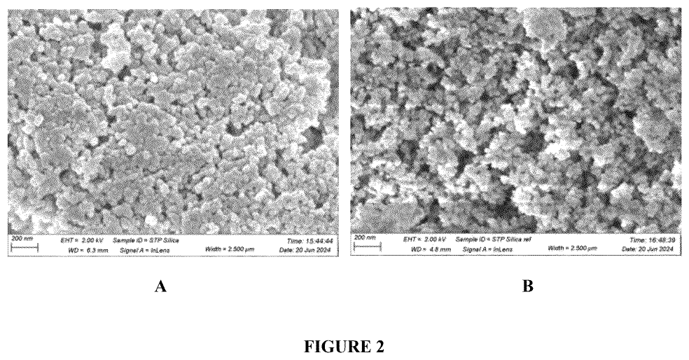

As shown in FIG. 2, the silica morphology was kept intact through the recycling process. FIG. 2 includes the scanning electron microscope (SEM) images of recycled silica (“A”) compared to a commercially available (non-recycled) silica typically used for the STP sealant (“B”).

### Example 3. Recycled Functionalized Silicone Oil

The functionalized silicone oil can be obtained by the following procedure: 50 g of the silicone tubing crumbs were placed into a 1 L round flask. 500 mL tetrahydrofuran was filled in the same flask. Consequently, 5 mL 1M TBAF solution was added to the same flask then stirred at least 8 h until all the tubing crumbs were depolymerized. The resulting solution was filtered by centrifuging at 9500 rpm for 30 minutes. The separated silica was dried for 18 h under 80° C. The supernatant was transferred back to the original flask and 0.1 M 1,3-divinyltetramethyldisiloxane was added to the solution for another 24 h. Then the recycled silicone oil was obtained after the distillation under vacuum at 40° C. The molecular weight was characterized by gel permission chromatography (GPC) and the average molecular weight was 5400 g/mol. The summarized results are shown in the Table 3.

TABLE 3

| | Mw (Da) | Mn (Da) | PDI |
|---|---|---|---|
| Recycled vinyl functionalized Silicone | 5400 | 2900 | 1.3 |

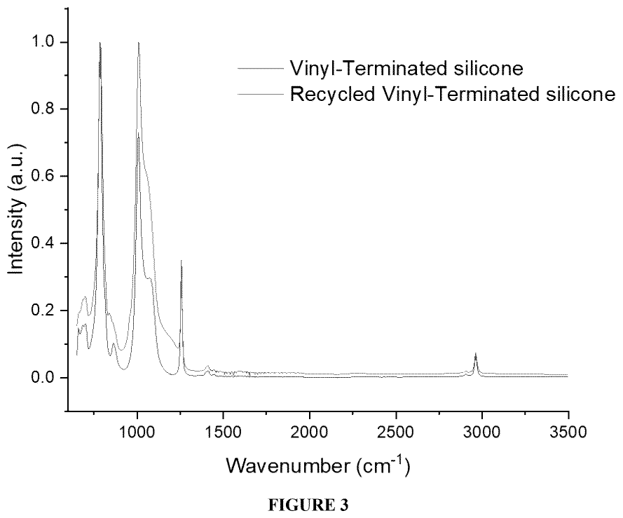

In FIG. 3, the peaks at 1405-1468 cm-1 correspond to the vinyl functional groups of the recycled silicone oil (PDMS) as compared to a commercially available DMS-V21 PDMS (non-recycled) available from Gelest. Clearly, a vinyl-functionalized recycled silicone oil was achieved.

Note that not all of the activities described above in the general description, or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, and may also be provided in combination in a single embodiment. Conversely, various features that are, for brevity, described in the context of a single embodiment, may also be provided separately or in any subcombination. Further, references to values stated in ranges include each and every value within that range.

What is claimed is:

1. A population of recycled silica particles, comprising: a plurality of individual silica particles, wherein the silica particles are hydrophobic.

2. The population in accordance with claim 1, wherein the hydrophobic silica particles have a surface having a water contact angle of greater than 50°, such as greater than 75°, such as greater than 100°, such as greater than 125°, or even greater than 150°.

3. The population in accordance with claim 1, wherein the silica particles are catalytically reactive.

4. The population in accordance with claim 3, wherein the silica particles comprise a platinum content in the form of platinum ions, platinum nanoparticles, platinum organic complexes, or combination thereof.

5. The population in accordance with claim 4, wherein the platinum content is at least 1.0 ppm weight.

6. The population in accordance with claim 1, wherein the silica particles have a degradation temperature of greater than 300° C., such as greater than 350° C., such as greater than 400° C., such as greater than 450° C., or even greater than 500° C. with a degradation percentage of 5% to 15%.

7. The population in accordance with claim 1, wherein the silica particles have a surface area of 120 m²/g to 400 m²/g, such as 120 m²/g to 170 m²/g, such as 130 m²/g to 160 m²/g, such as 140 m²/g to 150 m²/g.

8. The population in accordance with claim 1, wherein the silica particles have a D50 particle size of greater than 15 μm, such as greater than 20 μm when dispersed in a solvent.

9. The population in accordance with claim 1, wherein the silica particles are recycled from a commercially available article comprising a polymer with at least one silicon-oxygen bond and a reinforcing silica filler.

10. The population in accordance with claim 9, wherein the polymer comprises a silicone rubber, a silane-terminated polyether, a silane-terminated polyester, a silane-terminated polyurethane, or combination thereof.

11. A method of recovering a population of recycled silica particles comprising:
a) providing a commercially available silicone article;
b) mechanically breaking the silicone article into multiple silicone pieces;
c) mixing a mixture comprising the silicone pieces, a solvent, and a catalyst, wherein the mixture provides a silicone oil and the population of recycled silica particles; and
d) separating the population of recycled silica particles from the solvent to provide a plurality of individual silica particles.

12. The method in accordance with claim 11, wherein the silicone article comprises a liquid silicone rubber, a high consistency rubber, a room temperature vulcanized rubber, a hyperbranched silicon resin, a polyhedral oligomeric silsesquioxane, or combination thereof.

13. The method in accordance with claim 11, wherein the catalyst comprises a source of fluoride.

14. The method in accordance with claim 11, wherein the catalyst comprises tetra-n-butylammonium fluoride, tetra-n-methylammonium fluoride, tetra-n-ethylammonium fluoride, a fluoride-containing ionic liquid with pyridine, a fluoride-containing ionic liquid with imidazole, hydrogen fluoride, sulfur hexafluoride, a silicofluoride, an alkali metal fluoride, or combination thereof.

15. The method in accordance with claim 11, wherein the solvent comprises an ether, a heterocyclic monomer, N-methyl-2-pyrrolidone, dimethylformamide, cyrene, γ-valerolactone, dimethyl isosorbide, tetrahydrofuran, 2-methyl tetrahydrofuran, cyclopentyl methyl ether, acetone, dimethyl sulfoxide, ethyl acetate, or combination thereof.

16. The method in accordance with claim 11, further comprising drying the plurality of silica particles.

17. The method in accordance with claim 16, wherein drying is at a temperature of 70° C. to 100° C. for at least 18 hours.

18. The method in accordance with claim 11, wherein the silica particles are hydrophobic.

19. The method in accordance with claim 11, wherein the silica particles are catalytically reactive.

20. The method in accordance with claim 11, wherein the silica particles comprise a platinum content in the form of platinum ions, platinum nanoparticles, platinum organic complexes, or combination thereof.
